(19) United States
(12) Patent Application Publication
(10) Pub. No.: US 2022/0398107 A1
(43) Pub. Date: Dec. 15, 2022

(54) RANKING FINITE REGULAR EXPRESSION FORMATS USING STATE MACHINES

(71) Applicant: International Business Machines Corporation, Armonk, NY (US)

(72) Inventors: Ariel FARKASH, Shimshit (IL); Micha Gideon MOFFIE, Zichron Yaakov (IL)

(21) Appl. No.: 17/348,034

(22) Filed: Jun. 15, 2021

(51) Int. Cl. G06F 9/448; G06F 7/02; G06F 17/11

(52) U.S. Cl. CPC G06F 9/4498; G06F 7/02; G06F 17/11

(57) ABSTRACT

An example system includes a processor to receive a valid instance of a finite regular expression format. The processor is to generate a state machine corresponding to the finite regular expression format. The processor is to recursively compute a number of matched strings for each state and transition in the generated state machine. The processor is to recursively rank the valid instance of the finite regular expression format using the generated state machine with the computed numbers of matched strings. The processor is to output a number rank for the valid instance of the finite regular expression format.

### BACKGROUND

The present techniques relate to data formats. More specifically, the techniques relate to ranking of formats that include finite regular expressions.

### SUMMARY

According to an embodiment described herein, a system can include processor to receive a valid instance of a finite regular expression format. The processor can also further generate a state machine corresponding to the finite regular expression format. The processor can also recursively compute a number of matched strings for each state and transition in the generated state machine. The processor can also recursively rank the valid instance of the finite regular expression format using the generated state machine with the computed numbers of matched strings. The processor can further output a number rank for the valid instance of the finite regular expression format. Thus, the system can provide a unique ranking for instance of finite regular expression formats.

According to another embodiment described herein, a method can include receiving, via a processor, a valid instance of a finite regular expression format. The method can further include generating, via the processor, a state machine corresponding to the finite regular expression format. The method can also further include recursively computing, via the processor, a number of matched strings for each state and transition in the generated state machine. The method can also include recursively ranking, via the processor, the valid instance of the finite regular expression format using the generated state machine. The method can also further include outputting, via the processor, a number rank for the valid instance of the finite regular expression format.

According to another embodiment described herein, a computer program product for ranking finite regular expressions can include computer-readable storage medium having program code embodied therewith. The computer readable storage medium is not a transitory signal per se. The program code executable by a processor to cause the processor to receive a valid instance of a finite regular expression format. The program code can also cause the processor to generate a state machine corresponding to the finite regular expression format. The program code can also cause the processor to recursively compute a number of matched strings for each state and transition in the generated state machine. The program code can also cause the processor to recursively rank the valid instance of the finite regular expression format using the generated state machine with the computed numbers of matched strings. The program code can also cause the processor to output a number rank for the valid instance of the finite regular expression format.

### BRIEF DESCRIPTION OF THE SEVERAL VIEWS OF THE DRAWINGS

FIG. 1 is a block diagram of an example system for masking composite formats including finite regular expression formats using a state machine;

FIG. 2A is a diagram of an example state machine being generated to rank a finite regular expression;

FIG. 2B is another diagram of an example state machine being generated to rank a finite regular expression;

FIG. 2C is another diagram of an example state machine being generated to rank a finite regular expression;

FIG. 2D is another diagram of an example state machine being generated to rank a finite regular expression;

FIG. 2E is another diagram of an example state machine being generated to rank a finite regular expression;

FIG. 2F is another diagram of an example state machine being generated to rank a finite regular expression;

FIG. 2G is another diagram of an example state machine being generated to rank a finite regular expression;

FIG. 2H is another diagram of an example state machine being used to rank a finite regular expression;

FIG. 3 is a block diagram of an example method for ranking instances of a finite regular expression using a state machine;

FIG. 4 is a block diagram of an example method for masking data using a rank-then-cipher of a finite regular expression;

FIG. 5 is a block diagram of an example computing device that can mask composite formats including finite regular expression formats using a state machine;

FIG. 6 is a diagram of an example cloud computing environment according to embodiments described herein;

FIG. 7 is a diagram of an example abstraction model layers according to embodiments described herein; and

FIG. 8 is an example tangible, non-transitory computer-readable medium that can mask composite formats including finite regular expression formats using a state machine.

### DETAILED DESCRIPTION

A framework may be capable of defining composite formats. A composite format, as used herein, is defined as a hierarchical composition of sub-formats in a recursive manner. Each sub-format is a format, and an instance of a composite format or a building block format. For example, a composite format may be a concatenation or a union of sub-formats. Examples of building block formats are provided in Table 1 below. A format, as used herein, is a data unit that can match, search, and rank itself. For example, a match may be given a string return a Boolean yes if string is a legal string in the format. A match may also include validation of any additional format restrictions. For example, a format restriction may be a checksum performed and validated against one of the digits of the format. Given a text, a search may search for occurrences of matches. In a rank, a given string of the format will produce a unique and consistent integer bound by the size of the domain. In various examples, the process may be reversible, thus, the original string can also be reproduced from a given integer.

However, including regular expressions as a sub-format in such a framework such that composite formats including regular expressions are supported may be difficult. In particular, regular expressions may be difficult to rank.

According to embodiments of the present disclosure, a system can include a processor to receive an instance of a finite regular expression format. The processor can generate a state machine corresponding to the finite regular expression format. The processor can recursively compute a number of matched strings for each state and transition in the generated state machine. The processor can recursively rank the instance of the finite regular expression format using the generated state machine with the computed numbers of matched strings. The embodiments herein thereby provide for a finite regular expression format type that is able to search, match, and rank itself. Thus, embodiments of the present disclosure enable composite formats to include finite regular expressions as sub-formats along with any other combination of other sub-formats. In particular, the embodiments use a regular expression match and search capabilities and provide for a one to one mapping for a match result to an integer that enables a ranking to be perform among all possible instances of the finite regular expression. Therefore, the embodiments also further enable a rank-then-cipher approach to be used to mask composite format instances that may include finite regular expressions, among other types of sub-formats.

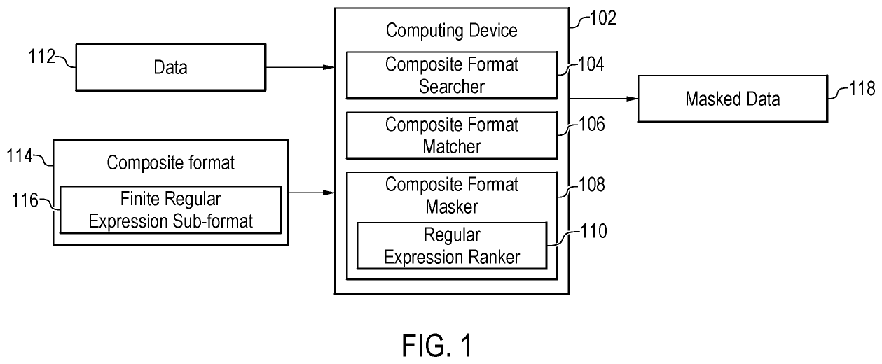

With reference now to FIG. 1, a block diagram shows an example system for masking composite formats including finite regular expression formats using a state machine. The example system 100 of FIG. 1 includes a computing device 102. As one example, the computing device 102 may be a cloud-based service that provides masking services for composite formats. The computing device 102 includes a composite format searcher 104, composite format matcher 106, and a composite format masker 108. The composite format masker 108 includes a regular expression ranker 110. The system 100 also includes data 112 and composite format 114 shown being received at the computing device 102. For example, the data 112 and composite format 114 may be received from another computing device (not shown). The composite format 114 includes a regular expression sub-format 116. For example, the composite format 114 may be a concatenation or union of sub-formats that include at least one regular expression sub-formats 116. The computing device 102 is also shown outputting masked data 118. For example, the masked data 118 may have one or more instances of the composite format 114 masked. In various examples, the masked data 118 may include portions of data that are encrypted or tokenized. For example, the encrypted or tokenized portions of masked data 118 may be any detected occurrences of the composite format 114.

As shown in FIG. 1, the computing device 102 may be provided with data 112 and composite format 114 and output masked data 118, in which any occurrences of the composite format 114 in the data 112 is masked. For example, the data 112 may include text corresponding to a composite format 114 to be searched and masked. In various examples, the sub-formats that the composite format 114 is built from include the regular expression sub-format 116 and any combination of building blocks or composite formats composed of additional sub-formats (not shown). As used herein, a building block refers to a format building block that is combinable with one or more other sub-formats via compositions to form a composite format 114. In various examples, a building block may be in the form of an Integer[Min,Max], FixedLengthPaddedInteger[Min, Max, Length], RealNumber[Min, Max, Precision], FixedLengthString[Alphabet, Length], VariableLengthString[Alphabet, MinLen, MaxLen], a finite RegularExpression, or a StringSet format. A set of example building block types with respective example values are shown in the table below:

TABLE 1
Build Block Types and Example Instances

| Building Block Types | Example Instances |
|---|---|
| Integer[Min,Max] | 134 |
| FixedLengthPaddedInteger | 0012 |
| [Min, Max, Length] | |
| RealNumber[Min, Max, Precision] | 23.45 |
| FixedLengthString[Alphabet, Length] | ABCDE, abcde |
| VariableLengthString | ABC, ABCD, abcde |
| [Alphabet,MinLen, MaxLen] | |
| Finite RegularExpression | \d{2,5]\.[A-Z]{3] |
| StringSet | [David, Jason, Michael] |

In various examples, the composite format 114 may be any suitable combination of sub-formats that can search, match, and rank themselves. For example, the combination of sub-formats may be a concatenation of sub-formats including the regular expression sub-format 116 and any other sub-format. A concatenation, as used herein, is a series of formats linked together. For example, the composite format CUST001 is an instance of a concatenation type composite format that includes two sub-formats: a CUST fixed string and an Integer range [1-700]. In some examples, the combination of sub-formats may be a concatenation or a union of sub-formats, one of which may be a regular expression sub-format 116. A union, as used herein, is a combination of interchangeable sub-formats. For example, the integer ranges format of [1-200, 300-500, 700-950] is an example union of three integer ranges that can be used interchangeably. In various examples, to enable each of the building blocks to search, match, and rank themselves, a textual pattern facet of each building block that is not a finite regular expression type sub-format may be implemented as an automatically generated regular expression. A generated regular expression, as used herein, is a sequence of characters that specifies a search pattern. As one example, the textual pattern facet of [0-27] may be represented using the regular expression: (?:1?[0-9])|2[0-7]). In addition, the composite format 114 can also search, match, and rank itself. In order to enable the composite format 114 to search, match, and rank itself, the composite textual patterns of the composite format 114 are implemented as a regular expression automatically generated by the regular expression generator 104 based on its sub-formats and composition type. For example, the composite textual pattern may be a regular expression representing a hierarchical structure of sub-formats represented as regular expressions. For example, the composite textual pattern [0-27, 80-89] may be represented using the regular expression: (?:1?[0-9])|2[0-7])|(?:8[0-9]). In this manner, the composite formats 114 may be able to map each part of an input string from data 112 to its corresponding sub-format for computing a composite ranking and unranking based on their sub-formats, as well as performing any additional validations. For example, the composite format 114 may be able to map a value of 26 to the first range or the value 82 to the second range of the composite textual pattern [0-27, 80-89]. Because validations may be performed at any level of the hierarchy, any such validation may rely on the mapping of the value in order to determine whether the value is to be validated. In addition, the mapping may be used to perform nested validations in which a sub-format is validated before a composite format is also validated.

In various examples, the composite format searcher 104 can search for occurrences of the composite format 114 in the data 112. For example, given a text from the data 112, the composite format searcher 104 can detect candidate matches of the composite format 114 in the text. The candidate matches may be strings of text in the data 112 that match the composite textual pattern of the composite format 114. The composite textual pattern of the composite format 114 may include the textual pattern of the finite regular expression sub-format 116. The composite format searcher 104 can then call a match( ) method on each of the detected occurrences of candidate matches. For example, the match( ) method may be executed by the composite format matcher 106.

In various examples, given a string in data 112, the composite format matcher 106 can return a Boolean yes if the string is a legal string in the composite format 114. For example, the given string may be a detected occurrence of a candidate match with the composite format 114 from the composite format searcher 104. In various examples, a regular expression generator (not shown) may first generate a regular expression that is the text pattern for the composition at hand. The finite regular expression sub-format 116 may be simply added to the text pattern because it is already a regular expression. For example, given a concatenation type composite format 114 that includes a finite regular expression sub-format 116, a concatenation of any number of regular expression sub-formats 116, and the generated regular expressions associated with any other sub-formats that may be included in the composite format 114, may be performed to create an overall regular expression. In some examples, the regular expression of each sub-format that is not a finite regular expression may also be recursively generated. In some examples, to map each sub-format to its respective text, sub-formats may be kept in capturing groups when generating regular expressions corresponding to composite format 114. For example, parentheses may be used to group regular expressions between the parentheses. The parentheses may thus be used to capture the text matched by the regular expression inside them into a numbered group that can be reused with a numbered backreference. The numbered backreferences may be used to map the regular expressions of each grouped sub-format to the respective text.

In various examples, the composite format matcher 106 can then run a regular expression match on given string against the regular expressions generated for the composite format 114, and return false if it does not match. In various examples, the composite format matcher 106 can decompose the given string to its sub-format matching using capturing groups and call a match on each sub-format with the respective sub-string. If any of the matching of the sub-formats fails, then the composite format matcher 106 may return a value of false. Otherwise, the composite format matcher 106 may return a value of true indicating that the given string matches the composite format 114, as well as any additional validations that may have been performed. In this manner, the composite format matcher 106 can validate both sub-formats as well as the format composition of the detected occurrences of a composite format 114.

Still referring to FIG. 1, given one or more validated legal strings of the composite format 114, the composite format masker 110 can mask such validated occurrences of composite formats 114 in the data 112 to generate masked data 118. In various examples, the composite format masker 110 can use a composite rank-then-cipher in order to mask the validated occurrences of composite format 114. For example, a composite rank-then-cipher may include ranking strings of the data 112 into integers and performing an integer format-preserving encryption (FPE). In a composite rank-then-cipher, strings may be encrypted in three steps, referred to herein as ranking, integer-format-preserving-encryption, and unranking. In various examples, for the ranking of a string s, an index i such that s=sᵢ may be found. For example, the composite format masker 110 can first produce a unique and consistent integer bound by the size of the domain of the composite format 112. For example, if 100 possible values exist for a given composite format 114, then the composite format masker 110 can generate a unique integer value for the specific string formatted in the composite format 114 from 1-100. In various examples, the composite format masker 110 can thus use the hierarchical structure of the composite format in order to parse the composite format 114 and determine a ranking for each sub-format and a relative ranking of the sub-formats to rank all possible combinations of the composite format 114. For finite regular expression subformats 116, the composite format masker 110 can receive the relative ranking of an instance of the finite regular expression subformats 116 from the regular expression ranker 108. Then, in some examples, the composite format masker 110 can execute an integer-encryption by encrypting index i into an index j, using an integer-FPE algorithm. In these examples, the cipher may be an encryption that is provided an integer i from the domain d [0,d.size), and returns an integer j in [0,d.size), that is only reversible using the encryption key. In various examples, the cipher operation may be a tokenization. For example, in a tokenization, the operation used to encrypt the integer may be a secure hash function, such as SHA-3. Thus, the given an integer i from the domain d [0,d.size), the tokenization may return an integer j in [0,d.size), that is consistent but not reversible. Finally, the unranking is performed to generate the encryption of s, which is the string sⱼ. In various examples, decryption may be performed in the same manner by replacing the integer-FPE encryption with the decryption algorithm. In some examples, the building blocks Integer[Min,Max], FixedLengthPaddedInteger[Min, Max, Length], and RealNumber[Min, Max, Precision], may be ranked using an integer domain ranking algorithm. The building blocks FixedLengthString[Alphabet, Length] and VariableLengthString[Alphabet, MinLen, MaxLen] may be ranked using a lexicographic ranking algorithm. The building block RegularExpression may be ranked using a state machine. The building block StringSet may be ranked using an enumeration ranking algorithm. In various examples, when the cipher operation is reversible, such as in encryption, the rank-and-cipher process is also reversible. Thus, given an integer of a particular composite format 114, a composite format unmasker (not shown) may reproduce the original string from data 112 that was masked in masked data 118.

The regular expression ranker 110 may provide a ranking for detected instances of the regular expression sub-format 116. For example, given an instance of a composite format 114 that includes a regular expression sub-format 116, the regular expression ranker 108 can determine the total possible instances of the regular expression sub-format 116 and then also rank each instances of the regular expression sub-format 116 with respect to all possible instances of the regular expression sub-format 116 using a state machine, as described herein.

In particular, the regular expression ranker 110 can generate a state machine based on the underlying finite regular expression with states and transitions representing characters and strings that are valid for the finite regular expression. In various examples, the regular expression ranker 110 can then recursively compute a number of matched strings for each state and transition in state machine. For example, the regular expression ranker 110 can traverse the state machine until an end state is reached. In various examples, the end state may be an accept state and a match of an empty string. The end state may then be increased by a value of 1. The regular expression ranker 110 can then compute the number of strings on a first transition. The number of matching strings on transitions (#trs_strs) may be recursively computed using the equation:

#trs_strs=#trs_chars*(destination)#state_strs Eq. 1

where #trs_chars is the number of characters on the transition, and (destination) #state_strs is the number of matching strings in a destination state. The regular expression ranker 110 can then also recursively compute the number of strings on source states. For example, the regular expression ranker 110 can compute the number of strings for each source state using the equation:

(source)#state_strs=Σ#trs_strs Eq. 2

where trs_strs is the number of matching strings on transition of each transition outgoing from the source state. In various examples, the regular expression ranker 110 can then compute a ranking for an instance of a finite regular expression using the augmented state machine.

In various examples, the regular expression ranker 110 can rank the finite regular expression by recursively traversing the instance character by character over the augmented state machine from the source state to the destination state. For example, for each character, the regular expression ranker 110 can first determine any outgoing transitions from a source state that precede the current transition including a current character. Any strings including such characters may be ranked lower than the current character and therefore the regular expression ranker 110 can accordingly rank the current character higher in response to detecting such characters. For example, the value #trs_strs representing the number of matching strings on outgoing transitions preceding the current transition can be added to the ranking of the current character. In addition, the regular expression ranker 110 can detect any preceding characters in the transition containing the current character. Such preceding characters would also have a lower ranking, and therefore the regular expression ranker 110 can further increase the ranking of the current character in response to detecting any preceding characters in the same transition. For example, the regular expression ranker 110 can compute the number of previous characters in the transition, multiply this number by the number of state strings in the destination state of the identified transition, and add the resulting product to the rank of the current character. In some examples, the regular expression ranker 110 can determine the ranking of the immediately previous character in a transition and then add one to determine the ranking of the current character. For example, the one can be added in response to detecting that the current transition leads to an accept state. The regular expression ranker 110 can then add the result of a recursive call to the next character of the instance and the destination state. In various examples, the regular expression ranker 110 can ignore following characters in the current transition and succeeding transitions. For example, such following characters and succeeding transitions include characters that would be ranked higher than the current character and therefore would not have any effect on its ranking.

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional data, formats, computing devices, or masked data, etc.).

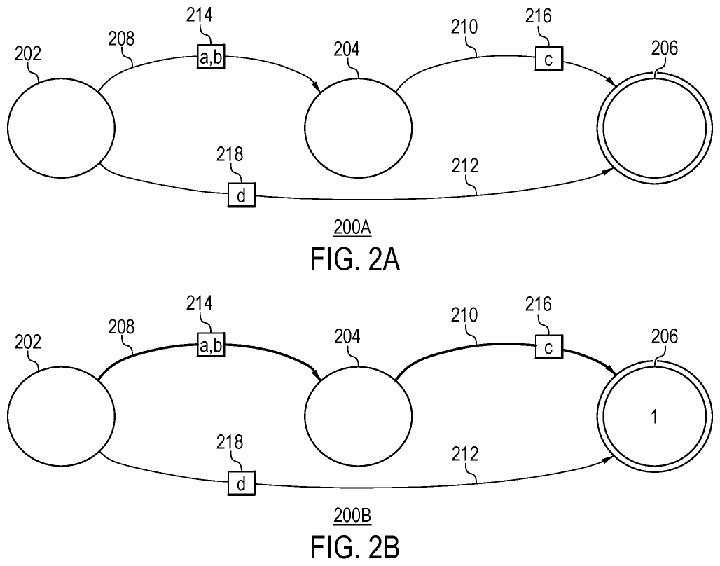

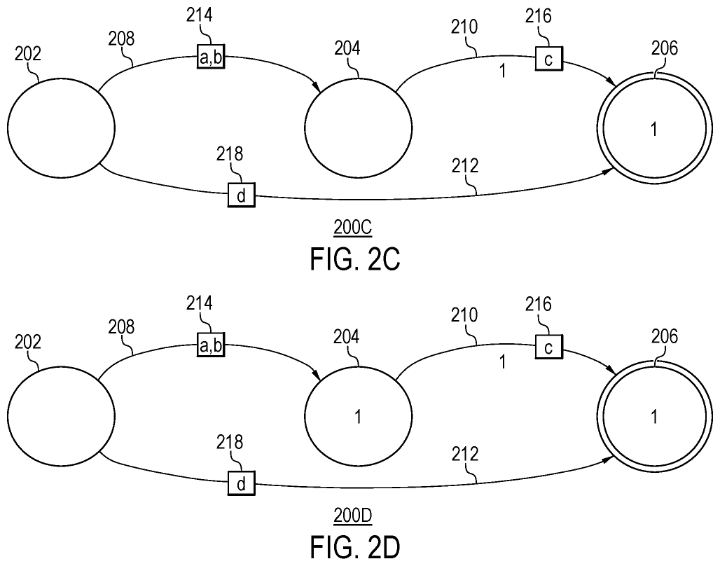

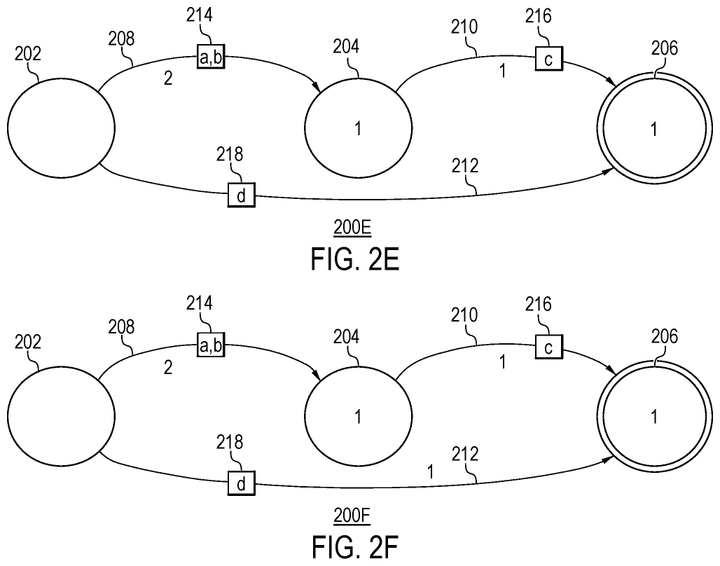

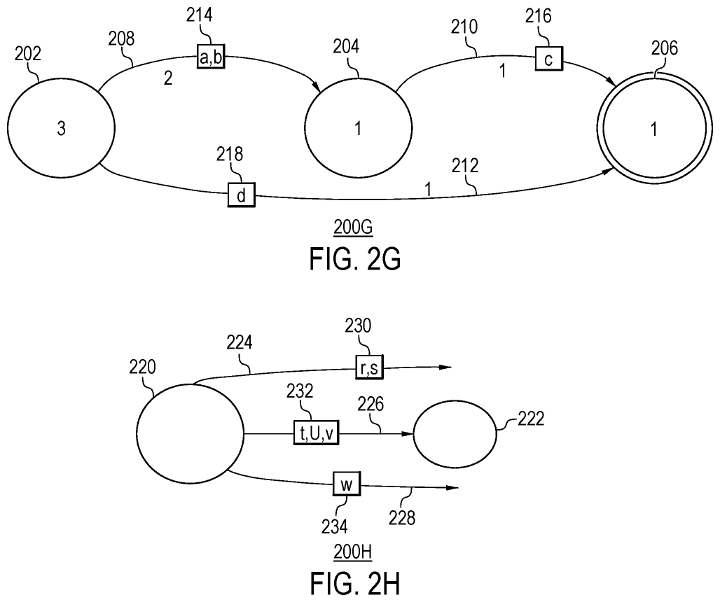

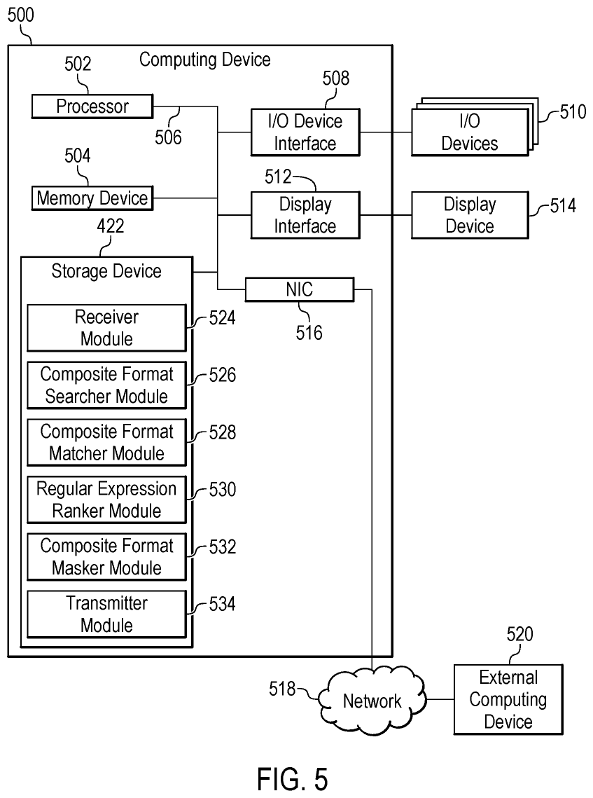

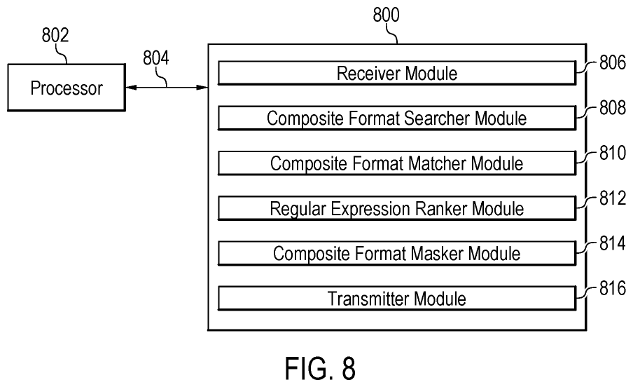

FIG. 2A is a diagram of an example state machine being generated to rank a finite regular expression. The example state machine 200A can be generated using the system 100 of FIG. 1 or the processor 502 or the processor 802 of FIGS. 5 and 8. The state machine 200A of FIG. 2A includes a source state 202, a state 204, and an accept state 206. The state machine 200A also includes a transition 208 from the state 202 to the state 204, a transition 210 from the state 204 to the accept state 206. The state machine 200A also further includes a transition 212 from the state 202 to the accept state 206. The transition 208 has a condition 214 of “a or b”. The transition 210 has a condition 216 of “c”. The transition 212 has a condition of “d”.

In the example of 2A, an example regular expression [ab]c|d is to be ranked using state machine such that an input string of “ac” is ranked as 1, an input string of “bc” is ranked as 2, and an input string of “d” is ranked last as 3. Thus, as shown in FIG. 2A, the first portion of [ab]c is modeled as a first transition with a condition 214 of “a or b” leading to state 204 and a second transition with a condition of “c” leading to the accept state 206. Because “d” is an alternative sufficient condition by itself, the state machine 200A also shows a transition 212 with condition “d” from the state 202 to the accept state. The initial state machine 200A generated for the example regular expression [ab]c|d can then be further augmented with additional computations to enable ranking, as described in FIGS. 2B-2H below.

FIG. 2B is another diagram of an example state machine being generated to rank a finite regular expression. FIG. 2B includes similarly referenced elements described in FIG. 2A. In the example state machine 200B of FIG. 2B, a preparation computation is performed. In particular, a number of matched strings for each state and transition in the state machine is computed recursively. In the example of 2B, the state machine 200B is traversed beginning with the state 202 to state 204 and ultimately to the accept state 206, at which a value of the state 204 is increased by 1 if an empty string is matched, which means that an end of an input string that is being processed was just reached as well. Thus, strings such as “acc” or “bcc” would not cause the accept state 206 to increase in value.

FIG. 2C is another diagram of an example state machine being generated to rank a finite regular expression. FIG. 2C includes similarly referenced elements described in FIG. 2A and continues the example of 2B. In FIG. 2C, after an accept state 206 is reached as shown in FIG. 2B, the original path taken in FIG. 2B is traced back and the transition 210 is updated with a value of 1 based on the value of 1 of the accept state 206 and the value of 1 transition character. Thus, the number of characters on transition (#trs-chars) for transition 210 is 1 and the number of matching strings in the destination state accept state 206 is 1, the number of matching strings on transition 210 can be calculated using Eq. 1 above as: 1×1=1.

FIG. 2D is another diagram of an example state machine being generated to rank a finite regular expression. FIG. 2D includes similarly referenced elements described in FIG. 2A and continues the example of 2C. In FIG. 2D, the original path taken in FIG. 2B is continued to recursively update the node corresponding to state 204 with a value of 1 based on the value of the transition 210. In particular, the state 204 is updated using Eq. 2. Because only one outgoing transition 210 leads from state 204, the summation only includes the value of the transition 210. Therefore the value of the number of strings for state 204 is 1.

FIG. 2E is another diagram of an example state machine being generated to rank a finite regular expression. FIG. 2E includes similarly referenced elements described in FIG. 2A and continues the example of 2D. In FIG. 2E, the transition 208 is updated with a value of 2 based on the number of characters on the transition 208 and the destination state 204. In the example of FIG. 2E, the transition 208 includes two characters a and b. In addition, the destination state 204 has a number of strings of one. Therefore, Eq. 1 can be used to calculate the number of matching strings on transition as 2*1=2.

FIG. 2F is another diagram of an example state machine being generated to rank a finite regular expression. FIG. 2F includes similarly referenced elements described in FIG. 2A and continues the example of 2E. In FIG. 2F, after the source state 202 is reached in FIG. 2E, the transition 212 is then updated with the value of 1 in response to traversing the state machine 200F and reaching the accepted state 206 via transition 212. The value of 1 is updated based on the value of the accept state 206 as in FIG. 2C. In particular, using Eq. 1, the number of characters on transition 212 is one and the number of matching strings in the destination state 206 is one. Therefore, the number of strings on transition 212 is calculated as 1*1=1.

FIG. 2G is another diagram of an example state machine being generated to rank a finite regular expression. FIG. 2G includes similarly referenced elements described in FIG. 2A and continues the example of 2F. In FIG. 2G, the number of transition strings for transition 208 and transition 212 are summed to generate the value 3 for the number of state strings for the source state 202. Thus, the processor can use Eq. 2 to calculate the value of source state 202 by summing the number of matching strings on transitions 208 and 212 resulting in a value of 2+1=3.

FIG. 2H is another diagram of an example state machine being used to rank a finite regular expression. The state machine 200H of FIG. 2H includes a source state 220 and a destination state 222. The state machine 200H also include a first transition 244, a second transition 226, and a third transition 228. The first transition 224 has a condition 230 of “r or s”. The second transition 226 has a condition 232 of “t, u, or v”. The third transition 228 has a condition 234 of “w”. The second transition 226 couples the source state 220 to the destination state 222.

In various examples, a processor can traverse a string and state machine character by character recursively. In the example of FIG. 2H, the processor is shown in the process of ranking an example character “u”. For this character, the processor can identify a corresponding transition. For example, the transition for character “u” is transition 226. The processor can then add the number of matching strings on outgoing transition 224 preceding the current transition 226 to the rank. The processor can then determine that there is one previous character tin transition 226, and multiple 1 by the number of state strings in the destination state 222, and add the resulting product to the rank of the current character “u”. The processor can then add one to the ranking in response to detecting that the transition 226 reaches accept state 222.

In various examples, the process may be repeated for each character of an instance of a finite regular expression. The rankings of the characters of the instance may be summed together to result in a unique ranking for the instance.

As one example, applying the process described in FIG. 2H to the string “bc” using the augmented state machine of FIG. 2G, the processor can drill down the recursion until the transition containing an empty string and the end state, and return 0. Then, in a back recursion, the processor can then process the transition 210 containing condition “c” add+1 to the rank in response to detecting that “c” reaches the accept state 206. The processor can then handle transition 208 containing “a or b” and connected to source state 202. The processor can add to the rank the number of previous characters to “b”, which is a total of one “a”, and multiplies this by the destination state 204 to get a value of one. The processor adds this to the ranking of c in order to get a final rank of “2”.

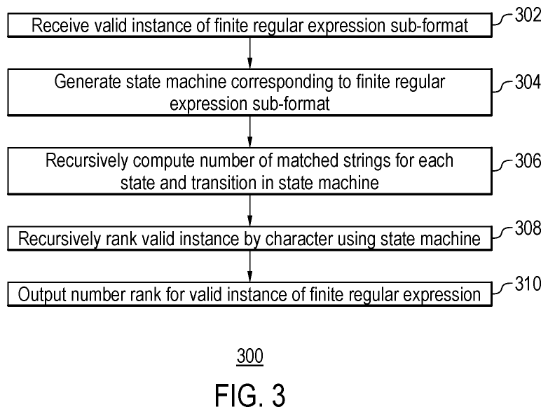

FIG. 3 is a process flow diagram of an example method for ranking instances of a finite regular expression using a state machine. The method 300 can be implemented with any suitable computing device, such as the computing device 500 of FIG. 5 and is described with reference to the systems 100 of FIG. 1. For example, the methods described below can be implemented by the processor 502 or the processor 802 of FIGS. 5 and 8.

At block 302, a processor receives a valid instance of a finite regular expression format. For example, the valid instance of the finite regular expression format may be part of a detected valid instance of a composite format.

At block 304, the processor generates a state machine corresponding to the finite regular expression format. For example, the transitions of the state machine may include conditions corresponding to the characters of the finite regular expression format. The states of the state machine may correspond to ordered positions of the possible characters.

At block 306, the processor recursively computes a number of matched strings for each state and transition in the generated state machine. In various examples, the processor traversing the state machine until an accept state is reached with a matching empty string and increasing the accept state by a value of one. In some examples, recursively computing the number of matched strings for a state includes summing numbers of matching strings on outgoing transitions of the state. In various examples, recursively computing the number of matched strings for a transition includes multiplying a number of characters on the transition by a number of matching strings in a destination state of the transition.

At block 308, the processor recursively ranks the instance of the finite regular expression format using the generated state machine with the computed numbers of matched strings. In various examples, recursively ranking the instance includes recursively traversing the instance character by character over the state machine. For example, recursively ranking the instance comprises, for each character of the instance, identifying a current transition in the state machine corresponding to the character and adding to the ranking of the instance: a number of matching strings on transition of any outgoing transitions preceding the current transition, a number of previous characters in the current transition multiplied by a number of state strings in the destination state of the current transition, one in response to the current transition reaching an accept state, and a result of a recursive call to a next character of the instance and destination state. In various examples, the processor ignores following characters in the current transition and succeeding transitions when ranking the instance.

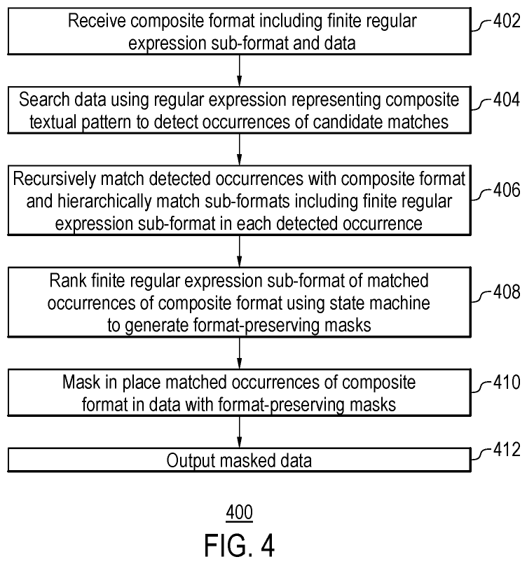

At block 310, the processor outputs a number rank for the valid instance of the finite regular expression. For example, the number rank may be a unique rank for the valid instance with respect to all other possible instances of the finite regular expression. In various examples, the number rank may be output to a composite ranker for use in ranking an instance of a composite format, as discussed with respect to FIG. 4.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

FIG. 4 is a process flow diagram of an example method for masking data using a rank-then-cipher of a finite regular expression. The method 400 can be implemented with any suitable computing device, such as the computing device 500 of FIG. 5 and is described with reference to the systems 100 of FIG. 1. For example, the methods described below can be implemented by the processor 502 or the processor 802 of FIGS. 5 and 8.

At block 402, a processor receives a composite format including a finite regular expression sub-format and data. For example, the composite format may be a concatenation or a union of sub-formats that includes a finite regular expression sub-format.

At block 404, the processor searches the data using regular expression representing composite textual patterns to detect occurrences of candidate matches. For example, the processor can convert the composite format into a regular expression and search the data using the composite textual pattern corresponding to the composite format.

At block 406, the processor recursively matches detected occurrences with composite format and hierarchically match sub-formats including finite regular expression sub-format in each detected occurrence. In some examples, the processor also validates any format restrictions. For example, the format restrictions may include checksums or any other suitable format restriction.

At block 408, the processor ranks the finite regular expression sub-format of matched occurrences of composite format using a state machine to generate format-preserving masks. For example, the finite regular expression can be ranked using the method 300 of FIG. 3. In various examples, once the finite regular expression is ranked, the composite format can be ranked and converted into an integer using a rank-then-cipher method. In some examples, an encryption or tokenization of the integer may be performed to generate an encrypted or tokenized integer. The encrypted or tokenized integer may be converted into a corresponding instance of the composite format to be used as a format-preserving mask.

At block 410, the processor masks in place matched occurrences of composite format in data with format-preserving masks. For example, validated instances of the composite format may be replaced with the format-preserving mask in the data.

At block 412, the processor outputs the masked data. For example, the masked data may be output to an application to be used as test data during a validation of the application.

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 5 is block diagram of an example computing device that can mask composite formats including finite regular expression formats using a state machine. The computing device 500 may be for example, a server, desktop computer, laptop computer, tablet computer, or smartphone. In some examples, computing device 500 may be a cloud computing node. Computing device 500 may be described in the general context of computer system executable instructions, such as program modules, being executed by a computer system. Generally, program modules may include routines, programs, objects, components, logic, data structures, and so on that perform particular tasks or implement particular abstract data types. Computing device 500 may be practiced in distributed cloud computing environments where tasks are performed by remote processing devices that are linked through a communications network. In a distributed cloud computing environment, program modules may be located in both local and remote computer system storage media including memory storage devices.

The computing device 500 may include a processor 502 that is to execute stored instructions, a memory device 504 to provide temporary memory space for operations of said instructions during operation. The processor can be a single-core processor, multi-core processor, computing cluster, or any number of other configurations. The memory 504 can include random access memory (RAM), read only memory, flash memory, or any other suitable memory systems.

The processor 502 may be connected through a system interconnect 506 (e.g., PCI®, PCI-Express®, etc.) to an input/output (I/O) device interface 508 adapted to connect the computing device 500 to one or more I/O devices 510. The I/O devices 510 may include, for example, a keyboard and a pointing device, wherein the pointing device may include a touchpad or a touchscreen, among others. The I/O devices 510 may be built-in components of the computing device 500, or may be devices that are externally connected to the computing device 500.

The processor 502 may also be linked through the system interconnect 506 to a display interface 512 adapted to connect the computing device 500 to a display device 514. The display device 514 may include a display screen that is a built-in component of the computing device 500. The display device 514 may also include a computer monitor, television, or projector, among others, that is externally connected to the computing device 500. In addition, a network interface controller (NIC) 516 may be adapted to connect the computing device 500 through the system interconnect 506 to the network 518. In some embodiments, the NIC 516 can transmit data using any suitable interface or protocol, such as the internet small computer system interface, among others. The network 518 may be a cellular network, a radio network, a wide area network (WAN), a local area network (LAN), or the Internet, among others. An external computing device 520 may connect to the computing device 500 through the network 518. In some examples, external computing device 520 may be an external webserver 520. In some examples, external computing device 520 may be a cloud computing node.

The processor 502 may also be linked through the system interconnect 506 to a storage device 522 that can include a hard drive, an optical drive, a USB flash drive, an array of drives, or any combinations thereof. In some examples, the storage device may include a receiver module 524, a composite format searcher module 526, a composite format matcher module 528, a regular expression ranker module 530, a composite format masker module 532, and a transmitter module 534. The receiver module 524 can receive a composite format including a finite regular expression sub-format and data. The composite format searcher module 526 can search the data using regular expression representing composite textual patterns to detect occurrences of candidate matches. The composite format matcher module 528 can recursively match detected occurrences with composite format and hierarchically match sub-formats including finite regular expression sub-format in each detected occurrence. The regular expression ranker module 530 can receive a valid instance of a finite regular expression format and generate a state machine corresponding to the finite regular expression format. In various examples, each valid instance of the finite regular expression format is able to reach an accept state in the generated state machine. For example, each possible match of the finite regular expression following a path to an accept state in the state machine is to receive a unique ranking. The regular expression ranker module 530 can recursively compute a number of matched strings for each state and transition in the generated state machine. In various examples, to recursively compute the number of matched strings for a state, the regular expression ranker module 530 can, sum numbers of matching strings on outgoing transitions of the state. In various examples, to recursively compute the number of matched strings for a transition, the regular expression ranker module 530 can multiply a number of characters on the transition by a number of matching strings in a destination state of the transition. The regular expression ranker module 530 can recursively rank the valid instance of the finite regular expression format using the generated state machine with the computed numbers of matched strings. In various examples, to recursively rank the valid instance, the regular expression ranker module 530 can recursively traverse the valid instance character by character over the state machine. In some examples, the regular expression ranker module 530 can, for each character of the valid instance, identify a current transition in the state machine corresponding to the character, and add to the ranking of the valid instance: a number of matching strings on transition of any transitions preceding the current transition, a number of previous characters of in the current transition multiplied by a number of state strings in the destination state of the current transition, one in response to the current transition reaching an accept state, and a result of a call to a next character and destination state. The regular expression ranker module 530 can then output a number rank for the valid instance of the finite regular expression format. A composite format masker module 532 can generate a format-preserving mask based on the ranking of the valid instance and a cipher function. For example, the composite format masker module 532 can generate a format-preserving encryption or format-preserving tokenization using a rank-then-cipher of the valid instance to be masked. In various examples, the composite format masker module 532 can mask in place matched occurrences of composite format in data with the format-preserving mask. A transmitter module 534 can transmit the masked data. For example, the transmitter module 534 can output the masked data to an application to be used as test data during a validation of the application.

It is to be understood that the block diagram of FIG. 5 is not intended to indicate that the computing device 500 is to include all of the components shown in FIG. 5. Rather, the computing device 500 can include fewer or additional components not illustrated in FIG. 5 (e.g., additional memory components, embedded controllers, modules, additional network interfaces, etc.). Furthermore, any of the functionalities of the receiver module 524, the composite format searcher module 526, the composite format matcher module 528, the regular expression ranker module 530, the composite format masker module 532, and the transmitter module 534 may be partially, or entirely, implemented in hardware and/or in the processor 502. For example, the functionality may be implemented with an application specific integrated circuit, logic implemented in an embedded controller, or in logic implemented in the processor 502, among others. In some embodiments, the functionalities of the receiver module 524, composite format searcher module 526, and composite format matcher module 528, the regular expression ranker module 530, the composite format masker module 532, and the transmitter module 534, can be implemented with logic, wherein the logic, as referred to herein, can include any suitable hardware (e.g., a processor, among others), software (e.g., an application, among others), firmware, or any suitable combination of hardware, software, and firmware.

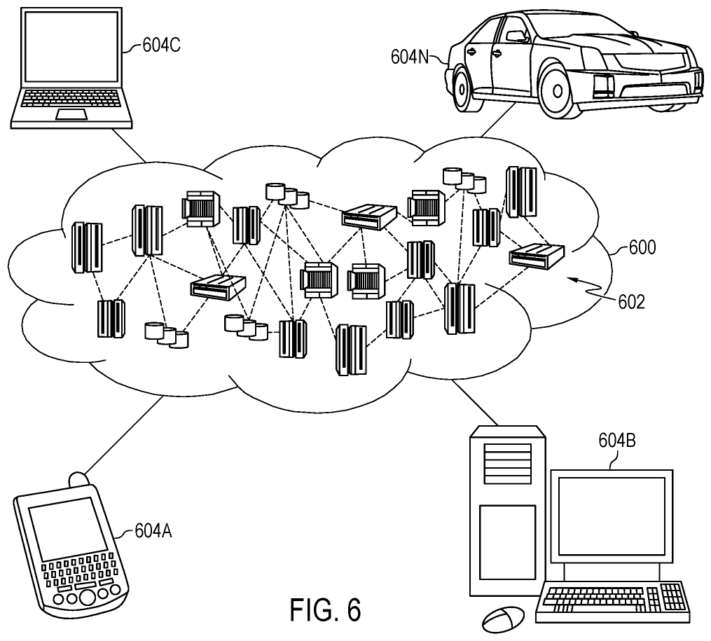

Referring now to FIG. 6, illustrative cloud computing environment 600 is depicted. As shown, cloud computing environment 600 includes one or more cloud computing nodes 602 with which local computing devices used by cloud consumers, such as, for example, personal digital assistant (PDA) or cellular telephone 604A, desktop computer 604B, laptop computer 604C, and/or automobile computer system 604N may communicate. Nodes 602 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 604A-N shown in FIG. 6 are intended to be illustrative only and that computing nodes 602 and cloud computing environment 600 can communicate with any type of computerized device over any type of network and/or network addressable connection (e.g., using a web browser).

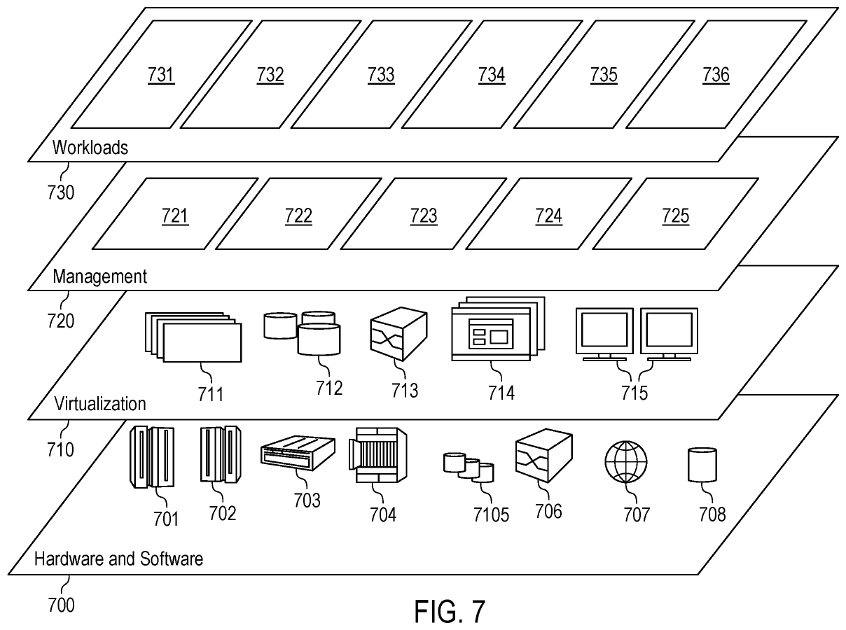

Referring now to FIG. 7, a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 700 includes hardware and software components. Examples of hardware components include: mainframes 701; RISC (Reduced Instruction Set Computer) architecture based servers 702; servers 703; blade servers 704; storage devices 705; and networks and networking components 706. In some embodiments, software components include network application server software 707 and database software 708.

Virtualization layer 710 provides an abstraction layer from which the following examples of virtual entities may be provided: virtual servers 711; virtual storage 712; virtual networks 713, including virtual private networks; virtual applications and operating systems 714; and virtual clients 715.

In one example, management layer 720 may provide the functions described below. Resource provisioning 721 provides dynamic procurement of computing resources and other resources that are utilized to perform tasks within the cloud computing environment. Metering and Pricing 722 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 723 provides access to the cloud computing environment for consumers and system administrators. Service level management 724 provides cloud computing resource allocation and management such that required service levels are met. Service Level Agreement (SLA) planning and fulfillment 725 provide pre-arrangement for, and procurement of, cloud computing resources for which a future requirement is anticipated in accordance with an SLA.

Workloads layer 730 provides examples of functionality for which the cloud computing environment may be utilized. Examples of workloads and functions which may be provided from this layer include: mapping and navigation 731; software development and lifecycle management 732; virtual classroom education delivery 733; data analytics processing 734; transaction processing 735; and finite regular expression ranking 736.

The present invention may be a system, a method and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Referring now to FIG. 8, a block diagram is depicted of an example tangible, non-transitory computer-readable medium 800 that can rank mask composite formats including finite regular expression formats using a state machine. The tangible, non-transitory, computer-readable medium 800 may be accessed by a processor 802 over a computer interconnect 804. Furthermore, the tangible, non-transitory, computer-readable medium 800 may include code to direct the processor 802 to perform the operations of the methods 300 and 400 of FIGS. 3 and 4.

The various software components discussed herein may be stored on the tangible, non-transitory, computer-readable medium 800, as indicated in FIG. 8. For example, a receiver module 806 includes code to receive a composite format including a finite regular expression and data. A composite format searcher module 808 includes code to search the data using regular expression representing composite textual patterns to detect occurrences of candidate matches. A composite format matcher module 810 includes code to recursively match detected occurrences with composite format and hierarchically match sub-formats including finite regular expression sub-format in each detected occurrence. A regular expression ranker module 812 includes code to receive a valid instance of a finite regular expression format and generate a state machine corresponding to the finite regular expression format. The regular expression ranker module 812 includes code to recursively compute a number of matched strings for each state and transition in the generated state machine. In various examples, the regular expression ranker module 812 includes code to sum numbers of matching strings on outgoing transitions of the state. In various examples, the regular expression ranker module 812 includes code to multiply a number of characters on the transition by a number of matching strings in a destination state of the transition. The regular expression ranker module 812 includes code to recursively rank the valid instance of the finite regular expression format using the generated state machine with the computed numbers of matched strings. In various examples, the regular expression ranker module 812 includes code to recursively traverse the valid instance character by character over the state machine and compute the ranking of the valid instance. In some examples, the regular expression ranker module 812 includes code to, for each character of the valid instance, identify a current transition in the state machine corresponding to the character, and add to the ranking of the valid instance: a number of matching strings on transition of any transitions preceding the current transition, a number of previous characters of in the current transition multiplied by a number of state strings in the destination state of the current transition, one in response to the current transition reaching an accept state, and a result of a call to a next character of the valid instance and destination state. In various examples, the regular expression ranker module 812 includes code to output a number rank for the valid instance of the finite regular expression format. A composite format masker module 814 includes code to generate a format-preserving mask based on the ranking of the valid instance and a cipher function. For example, the composite format masker module 814 includes code to generate a format-preserving encryption or format-preserving tokenization using a rank-then-cipher of the valid instance to be masked. In various examples, the composite format masker module 814 includes code to mask in place matched occurrences of composite format in data with the format-preserving mask. A transmitter module 816 includes code to transmit the masked data. For example, the transmitter module 816 includes code to output the masked data to an application to be used as test data during a validation of the application.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIG. 8 may be included within the tangible, non-transitory, computer-readable medium 800, depending on the specific application.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive a valid instance of a finite regular expression format;
generate a state machine corresponding to the finite regular expression format;
recursively compute a number of matched strings for each state and transition in the generated state machine;
recursively rank the valid instance of the finite regular expression format using the generated state machine with the computed numbers of matched strings; and
output a number rank for the valid instance of the finite regular expression format.

2. The system of claim 1, wherein each valid instance of the finite regular expression format is able to reach an accept state in the generated state machine.

3. The system of claim 1, wherein each possible match of the finite regular expression following a path to an accept state in the state machine is to receive a unique ranking.

4. The system of claim 1, wherein the processor is to generate a format-preserving mask based on the ranking of the valid instance and a cipher function.

5. The system of claim 1, wherein, to recursively compute the number of matched strings for a state, the processor is to sum numbers of matching strings on outgoing transitions of the state.

6. The system of claim 1, wherein, to recursively compute the number of matched strings for a transition, the processor is to multiplying a number of characters on the transition by a number of matching strings in a destination state of the transition.

7. The system of claim 1, wherein, to recursively rank the valid instance, the processor is to recursively traverse the valid instance character by character over the state machine and compute the ranking of the valid instance.

8. A computer-implemented method, comprising:
receiving, via a processor, a valid instance of a finite regular expression format;
generating, via the processor, a state machine corresponding to the finite regular expression format;
recursively computing, via the processor, a number of matched strings for each state and transition in the generated state machine;
recursively ranking, via the processor, the valid instance of the finite regular expression format using the generated state machine; and
outputting, via the processor, a number rank for the valid instance of the finite regular expression format.

9. The computer-implemented method of claim 8, further comprising generating, via the processor, a format-preserving mask based on the ranking of the valid instance.

10. The computer-implemented method of claim 8, comprising traversing the state machine until an accept state is reached with a matching empty string and increasing the accept state by a value of one.

11. The computer-implemented method of claim 8, wherein recursively computing the number of matched strings for a state comprises summing numbers of matching strings on outgoing transitions of the state.

12. The computer-implemented method of claim 8, wherein recursively computing the number of matched strings for a transition comprises multiplying a number of characters on the transition by a number of matching strings in a destination state of the transition.

13. The computer-implemented method of claim 8, wherein recursively ranking the valid instance comprises recursively traversing the valid instance character by character over the state machine and computing the ranking of the valid instance.

14. The computer-implemented method of claim 8, wherein recursively ranking the valid instance comprises, for each character of the valid instance:
identifying a current transition in the state machine corresponding to the character; and
adding to the ranking of the valid instance:
a number of matching strings on transition of any outgoing transitions preceding the current transition;
a number of previous characters in the current transition multiplied by a number of state strings in the destination state of the current transition;
one in response to the current transition reaching an accept state; and
a result of a recursive call to a next character of the valid instance and destination state.

15. A computer program product for ranking finite regular expressions, the computer program product comprising a computer-readable storage medium having program code embodied therewith, wherein the computer-readable storage medium is not a transitory signal per se, the program code executable by a processor to cause the processor to:
receive a valid instance of a finite regular expression format;
generate a state machine corresponding to the finite regular expression format;
recursively compute a number of matched strings for each state and transition in the generated state machine;
recursively rank the valid instance of the finite regular expression format using the generated state machine with the computed numbers of matched strings; and
output a number rank for the valid instance of the finite regular expression format.

16. The computer program product of claim 15, further comprising program code executable by the processor to generate a format-preserving mask based on the ranking of the valid instance and a cipher function.

17. The computer program product of claim 15, further comprising program code executable by the processor to sum numbers of matching strings on outgoing transitions of the state.

18. The computer program product of claim 15, further comprising program code executable by the processor to multiply a number of characters on the transition by a number of matching strings in a destination state of the transition.

19. The computer program product of claim 15, further comprising program code executable by the processor to recursively traverse the valid instance character by character over the state machine and compute the ranking of the valid instance.

20. The computer program product of claim 15, further comprising program code executable by the processor to, for each character of the valid instance:
identify a current transition in the state machine corresponding to the character; and
add to the ranking of the valid instance:
a number of matching strings on transition of any outgoing transitions preceding the current transition;
a number of previous characters in the current transition multiplied by a number of state strings in the destination state of the current transition;
one in response to the current transition reaching an accept state; and
a result of a recursive call to a next character of the valid instance and destination state.
